(19) United States
(12) Patent Application Publication
(10) Pub. No.: US 2011/0114405 A1
(43) Pub. Date: May 19, 2011

(54) DRIVE ISOLATION SYSTEM FOR TRACTION ENGINE DRIVEN ACCESSORIES

(76) Inventor: Frank J. Perhats, Lake Barrington, IL (US)

(21) Appl. No.: 12/947,668

(22) Filed: Nov. 16, 2010

Related U.S. Application Data
(60) Provisional application No. 61/261,989, filed on Nov. 17, 2009.

(51) Int. Cl. B60K 11/02; B60K 11/06

(52) U.S. Cl. 180/68.1

(57) ABSTRACT

An energy recovery interior heating system has a modified mechanical or electrical drive isolation system for vehicles such as trucks. This permits a standard air conditioning compressor pump to be driven from multiple power inputs thereby providing any hybrid or non-hybrid vehicle with continuous engine-on heating and/or air conditioning, limited time engine-off heating and air conditioning and two types of engine-off air conditioning temperature modulation. Another combination of the heating and air conditioning systems would permit the continuation of heating and cooling on hybrid vehicles when they are stationary and their traction batteries are fully charged and the vehicle is operating only on the electric motors for traction or work load power. This invention also provides internal combustion engine-off heating and A/C on these types of vehicles. Another embodiment uses the drive isolation system to integrate auxiliary power unit (APU) functions as part of the traction engine of over the road trucks.

### CROSS REFERENCE TO RELATED APPLICATION

This application claims the benefit of U.S. Provisional Application No. 61/261,989, filed Nov. 17, 2009, which is incorporated herein by reference in its entirety.

### BACKGROUND OF THE INVENTION

Over the road or long haul trucks are frequently equipped with sleeping compartments located behind the cab. These sleeper compartments are equipped to provide space and domestic equipment ranging from a basic sleeping bunk to all of the amenities of a motor home.

During the past half century, when fuel costs were relatively inexpensive and environmental concerns virtually non existent, trucking industry habit was to simply idle the traction engine (i.e., the main engine of the truck) during the mandatory eight to twelve hours of rest, in order to provide interior heating, air conditioning and ventilation and other domestic amenities.

As concerns about the environment, conservation and fuel costs began to surface during the past decade, idling the vehicle's traction engine as a means for providing these comfort necessities began to be replaced by fuel-fired heaters or auxiliary power units (APU's). Alternately, although very costly to erect and maintain, truck parking plazas were built where plug-in services for heat and air conditioning were provided at significant cost to the driver as well as the provider.

These plazas are still few and far between and cost the driver enough to make the investment in an APU a viable alternative. Although the APU is the most practical alternative available to date, it still has significant shortcomings such as initial cost, installation and maintenance time and cost and weight and space penalties. The weight of the APU, although compensated for recently in trucking regulations, still detracts from hauling capacity, is costly to purchase and costly to operate and maintain.

These penalties stem from the duplication of existing traction engine driven components such as alternators, coolant pumps and air conditioning systems and duplication of engine operating systems such as radiators, fuel delivery and exhaust processing.

The present disclosure proposes to eliminate many of the stated shortcomings of these auxiliary power units as described above by utilizing a unique drive isolation system that enables the traction engine's existing engine driven accessories to be driven from a second or even a third power source. The integration of the traction and APU engine functions eliminates accessory duplication, reduces weight and volume, acquisition costs and the cost of servicing and maintaining duplicate systems.

The drive isolation system of this invention is also applicable to other types of vehicles such as electric or hydraulic hybrids, day cab trucks and smaller commercial and passenger vehicles for short term, no-idle interior air conditioning and heating.

The disclosure further proposes an even greater cost, weight and service cost reduction by proposing the integration or sharing of common auxiliary and traction engine operating systems where practical and possible. Some of these are engine coolant and cooling, fuel and fuel filtration and processing; sharing of engine lubricating oil, oil filtration; combustion air and air filtration; and engine exhaust and exhaust gas processing (catalytic and particulate filters where practical). When it becomes practical and as applicable to other vehicle types, this invention also proposes substituting an electric motor for the auxiliary internal combustion engine as the secondary accessory drive source; as for example whenever onboard high density electric storage capacity becomes available.

Further, the integration of the APU and traction engine, permits this invention to propose the use of an engine-off (no-idle) energy recovery system such as that sold under the trademark Autotherm® by Enthal systems, Inc. to provide long-term, engine-off cab or sleeper heating in cold weather. By sharing the traction engine coolant and cooling system, this invention proposes that the waste heat generated by the auxiliary engine be circulated thru the traction engine keeping it warm for easy restart while at the same time providing the heat for operation of the energy recovery system for long term, traction engine off interior heating.

In addition, when the auxiliary engine no longer needs to run, for example, when the driver is sleeping or when batteries are fully charged, the auxiliary engine is automatically shut down. The energy recovery heating system then continues to operate the vehicle's existing sleeper or bunk heater. When the energy recovery heating system terminates operation (when coolant temperature drops to approximately 95° F.), the auxiliary engine or a fuel-fired engine coolant heater can be restarted, reheating shared engine coolant and continuing interior heating until coolant temperature reaches normal engine operating temperature once again, cycling the fuel-fired or electric engine coolant heater on and off as needed. This permits the energy recovery system to shut the auxiliary engine off and continue engine-off interior heating for extended heating periods even in the coldest climates. The same energy recovery heating system would be used to provide traction-engine-off truck cab interior heating during the vehicle's day cab operations of loading, unloading, rest, meal and fueling stops and or air conditioning when called for.

In warm weather, or if engine coolant exceeds a fixed maximum temperature, auxiliary engine coolant is shunted by a valve, a pump or both, to the traction engine cooling radiator before returning to the traction engine block, thus maintaining engine coolant temperatures at acceptable levels while also operating the traction engine radiator cooling fans to cool the fluid flowing through the radiator.

A final proposal of this invention applies to: a) over the road trucks that have been electrified; b) defined as vehicles where electric motors selectively drive previously belt driven engine accessories on an as needed basis instead of constantly as is currently the case with belt drives; or c) to vehicles known as hybrid vehicles, hybrids being defined as vehicles having large banks of batteries or hydraulic accumulators recharged by vehicle motion or the internal combustion traction engine or integrated generator/electric motor or hydraulic pump that provides auxiliary power from stored energy when the traction engine is off.

The drive concept of this invention, as applied to engine driven accessories, then permits driving selected engine accessories, by way of either the primary, secondary or even a third drive input source. For example, the traction engine mounted A/C compressor could be driven using the isolation means of this invention on over the road sleeper trucks, day cab and small trucks, passenger cars and hybrids, by either the traction engine while the vehicle is driven, or by the auxiliary engine or electric drive motor when the truck is stationary, or by a third drive source, an electric motor for example that is coupled to the rear of the A/C compressor shaft via the inline coupling version of the drive isolation system of this invention.

On non-over the road vehicles, the drive isolation system of this invention enables driving the vehicle's existing air conditioning compressor via the engine's existing accessory belt drive system, by an electric motor when the engine is running or not running or by the electric motor when the engine is off on vehicles with sufficient electric storage capacity on board such as an electric hybrid vehicle.

For locomotion, hybrid passenger vehicles cycle between the internal combustion engine, the electric traction motor and the combination running of both to provide over the road locomotion. When batteries are fully charged, hybrid vehicles run over the road at city street speeds on the electric motor alone. When these hybrid vehicles are stationary at a stop light for example and the traction batteries are fully charged, neither of the traction engines will run and heating and cooling ceases. In very cold weather, the internal combustion engine is not permitted to shut off so as to provide continued cab heating under such conditions. This invention would permit both short term heating and air conditioning to continue under these conditions.

This invention enables hybrid passenger vehicles equipped with an energy recovery heating system such as the Autotherm® system, to provide, in cold weather, continued heating while standing at stoplights with the internal combustion engine off as well as providing prolonged short term interior heating when the vehicle is parked, while also providing short term temperature modified air conditioning with the electric or internal combustion engine off in warm weather.

The temperature-modified, engine-off air conditioning is provided by the energy recovery heating system powering the existing vehicle heater with the traction engine off, which enables full mix door operation of the HVAC system and thus provides the same temperature control modulation of air conditioning temperatures as is provided when the engine is running and the vehicle is being driven.

The invention as proposed herein, is well suited for use in both modified standard vehicles and for incorporation into vehicles having large amounts of available stored electrical energy on board, known as hybrid electric vehicles.

Hybrid vehicles currently fall into two main sub-categories or operating classes. The first are those mentioned above that function mostly as passenger vehicles or light delivery vehicles and have two power sources for accelerating and sustaining the vehicle in motion, these being a separate or combination use of an internal combustion engine and an electric motor operating individually or in unison to provide acceleration, forward motion and battery charging. The second type uses the internal combustion traction engine to provide propulsion and the recharging of a large capacity electrical or hydraulic storage supply which is then used while the vehicle is stationary at a work site, to supply power to secondary, work related systems such as boom arms or lift gates previously operated from the traction engine driven power takeoff shafts or PTO's.

These types of vehicles are most frequently used by crews in construction or maintenance work where the vehicle is stationary for long periods of time and idling the traction engine is used to provide power for various job site functions. Current bucket trucks are a good example. They are used by utility companies to access high pole areas for wire installation or repair. The arm supporting and moving the workman occupied and controlled bucket is hydraulically powered from the PTO shaft of the continuously idling traction engine.

Because these older systems continually idle the traction engine, they can, under all weather conditions, automatically provide not only the necessary power for operating work related equipment but also are able to provide interior cab heating in cold weather and air conditioning in warm weather for the duration of the work shift. This is a direct benefit of the continuously idling traction engine. However, this is a very costly, fuel wasting, air polluting process which significantly shortens engine life and increases the cost and frequency of engine maintenance and repair.

The hybrid vehicle in turn, provides long periods of engine off time between electrical or hydraulic charging periods. This results in significantly long work periods without cabin heating or cooling which makes these environmentally compatible vehicles less desirable to the work crews. The installation of a no-idle energy recovery heating system automatically provides heat during these engine-off cycles by enabling the existing vehicle heater to recover the waste heat energy generated and paid for during the hydraulic or battery charging cycle. One aspect of this invention proposes to provide not only engine-off interior heating during these engine-off cycles but no-idle air conditioning as well. In another aspect the invention proposes to combine the two no-idle comfort systems to provide the same interior temperature modulation of the cooled air during these engine-off periods that is currently provided when the engine is running. It also proposes an alternate means to modulate the mechanically cooled air.

For a better understanding of the modulation aspects of this invention, a brief description of a modern electric hybrid vehicle heating and air conditioning system follows.

With the energy recovery heating system installed in such a vehicle, continuous cab interior heating is available even during the coldest periods. When the engine is turned on by the need for battery or hydraulic accumulator recharging, the energy recovery heating system automatically turns off and the cab heater operates normally. Normal operation entails pumping hot engine coolant to the heater keeping it functioning to heat the vehicle interior while also reheating the engine coolant for the next cycle of engine-off interior heating by the installed energy recovery heating system. When the engine stops running (because the hybrid battery or hydraulic accumulator are fully charged) the energy recovery heating system continues the operation of the heater providing the same heater control that was previously available when the engine was running. In both circumstances, cabin temperature modulation is controlled manually or automatically by servo motors that determine the percentage of incoming air that passes over the heated portion of the heater core and the percentage that bypasses it.

With air conditioning present on the vehicle and operating while the traction engine is running, the incoming air first passes over the functioning evaporator core which is cooled by the air conditioning compressor that in turn is operated by the running traction engine. This cold, dry air's temperature is then modulated to comfortable levels by passing a portion of it over the vehicle's functioning heater core prior to remixing as it enters the vehicle cabin.

By combining the energy recovery heating system with the engine-off air conditioning system of this invention, this invention proposes to provide engine-off heating, in combination with modulated engine-off air conditioning and proposes an alternate system of A/C modulation that employs electronic speed control of the electric A/C drive motor whether the engine is on or off. The benefit of this temperature modulation system is conservation of battery power and is most applicable to vehicles with limited stored electric power.

Finally, the isolation drive proposed herein is not limited to A/C compressors. As previously mentioned, it is applicable to other vehicle engine driven systems as well.

### SUMMARY OF THE INVENTION

This invention proposes to combine an energy recovery interior heating system as described above, with a modified and novel mechanical (or electrical) drive isolation system. This permits a standard air conditioning compressor pump, or other existing or future engine driven accessory providing cooled air, to be driven from multiple power inputs thereby providing any hybrid or non-hybrid vehicle with continuous engine-on heating and/or air conditioning, limited time engine-off heating and air conditioning and two types of engine-off air conditioning temperature modulation. The first type uses the energy recovery system to modulate the A/C temperature by means of partially blending the cold air through the heating portion of the engine-off powered heater. The second type modulates the temperature by varying the compressor drive motor speed.

Another combination of the heating and air conditioning systems is proposed for use on small lightweight passenger or light work vehicles. Installation of this combination system would then permit the continuation of heating and cooling on hybrid vehicle's when they are stationary and their traction batteries are fully charged and the vehicle is operating only on the electric motors for traction or work load power, with the internal combustion traction engine off. Currently, such vehicles in cold weather do not shut down the internal combustion engine even though the batteries are fully charged, because there would be no circulation means to provide hot water to the heater. This invention proposes to provide internal combustion engine-off heating and A/C on these types of vehicles. Some versions of the invention proposed here can be implemented as retrofit systems on certain types of vehicles while other versions are more suitable for installation as no-idle A/C and heating system on newly manufactured vehicles.

The concepts contained herein may also be incorporated as a new feature for newly manufactured non-hybrid vehicles that have sufficient onboard stored battery energy to allow operation of the existing A/C system from dual drive sources, the traction engine when it is operating or an electric motor or auxiliary internal combustion engine when the traction engine is off for short term heating and cooling.

A third embodiment of this invention proposes using the drive isolation system proposed herein to integrate auxiliary power unit (APU) functions as part of the traction engine of over the road trucks, thereby reducing initial costs, weight and volume penalties and decreasing initial cost and overall operating and maintenance costs in long haul trucking operations.

### BRIEF DESCRIPTION OF THE DRAWINGS

FIG. 1 is a diagrammatic section through the three components comprising a roller clutch when the pulley (or gear) is the rotational drive input member.

FIG. 2 is a view similar to FIG. 1, showing the same parts when the rotational drive input is from the shaft.

FIG. 3 is a side view of the pulley, roller clutch and shaft assembly when the pulley is the rotational drive input source.

FIG. 4 is a side view of the same assembly as FIG. 3 when the shaft is the rotational drive input source.

FIG. 5 is a cutaway view of a dual pulley, roller clutch assembly when located on the same shaft.

FIG. 6 is an illustration of the functioning of the roller clutch in an inline shaft to shaft coupling as would be the case in an inline electric motor drive of an air conditioning compressor.

FIG. 7 is a front elevation view of the inline shaft to shaft drive of FIG. 6 mounted on a traction engine and selectively driven by either the electric motor or the traction engine.

FIG. 7A is a top plan view of the inline shaft to shaft drive of FIG. 6 mounted on a traction engine and selectively driven by either the electric motor or the traction engine.

FIG. 8 is a front elevation view of the parallel belt drive of the compressor selectively driven by either the electric motor or the traction engine with A/C clutch actuation required for operation when driven by either drive source.

FIG. 8A is a top plan view of the parallel belt drive of the compressor selectively driven by either the electric motor or the traction engine with A/C clutch actuation required for operation when driven by either drive source.

FIG. 9 is a top plan view of a parallel belt drive of the compressor that bypasses the clutch when it is driven by the electric motor.

FIG. 10 is a top plan view of a dual belt drive that bypasses the A/C clutch of FIG. 8 by placing the A/C electric motor drive pulley between the compressor clutch and the compressor.

FIG. 11 is a circuit diagram of one of a number of no-idle energy recovery systems modified to control and modulate the cooled air temperature.

FIG. 12 is a box diagram of the shared cooling system of an auxiliary power unit (APU) integrated into the vehicle's traction engine.

FIG. 13 is a flow chart of the engines of FIG. 12 operating in summer when the engine coolant must be cooled.

### DETAILED DESCRIPTION OF THE INVENTION

The present invention proposes the use of roller clutches to isolate dual-pulley, dual-gear or parallel end-to-end coupled shaft drive systems from each other. This isolation then permits driving traction engine driven systems, such as alternators, generators, water pumps, fans and air conditioner compressors, from two or more power input sources. Each drive source is automatically isolated from the other as one drive source is powered up and the other becomes dormant. Isolation can also be obtained using electromagnetic or mechanically actuated clutches on the drive or driven source. Using the simpler and lower cost, non-power consuming roller clutch as the isolation system means permits engine-off air conditioning on many types of vehicles. It also permits integration of auxiliary power unit functions into the vehicle's traction engine. This enables an energy recovery system to recover waste heat energy not only for short term vehicle interior heating, but for the long term heating and temperature modified cooling of sleeper trucks, motor homes, military vehicles, passenger cars, hybrid vehicles or any vehicle utilizing a water cooled internal combustion traction engine.

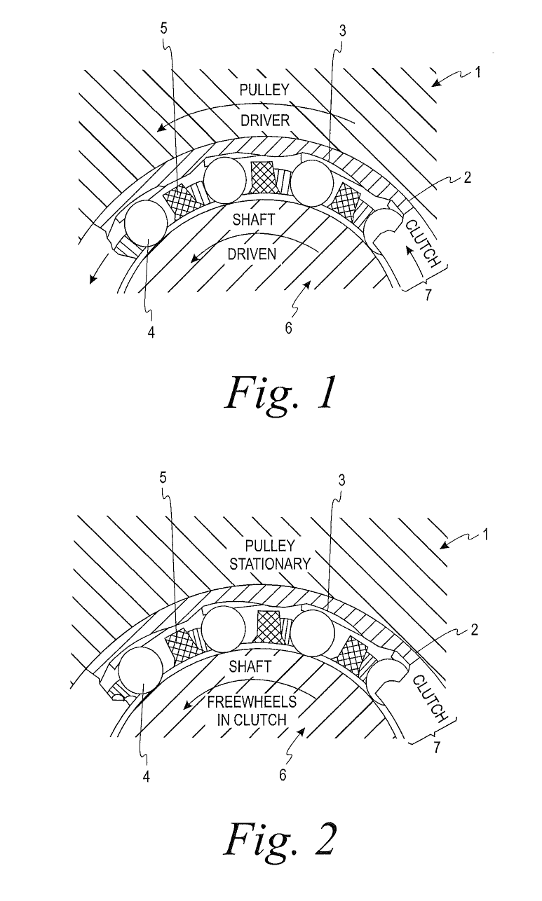

FIGS. 1 and 2 illustrate a sectioned view of the simpler and preferred combination of the three components involved in the drive system. These include clutch 7, shaft 6 and gear or pulley 1.

The pulley or gear 1 is affixed to the outer race 2 of the clutch 7. The inner circumference of outer race 2 contains wedge-shaped ramps 3 at each compartment containing a roller 4. Compartment separators 5 space rollers 4 evenly from each other around the circumference of clutch 7, permitting limited circumferential movement of each roller 4 within each roller space, depending on where rotational input originates. In FIG. 1, when pulley 1 rotates counterclockwise, outer race 2, being affixed to pulley 1, rotates counterclockwise as well thereby forcing ramp 3 to wedge roller 4 against shaft 6, which in turn locks pulley 1 and clutch assembly 7 to shaft 6, rotating it counterclockwise as well.

In FIG. 2 counterclockwise rotational input is from shaft 6 which causes rollers 4 to rotate counterclockwise away from ramp 3 thereby not locking freewheeling roller 4 to outer race 2 affixed to pulley 1, thereby imparting no wedging action to roller 4 or rotational force to pulley 1. Therefore, shaft 6 rotationally freewheels within the clutch 7 and pulley 1 assembly.

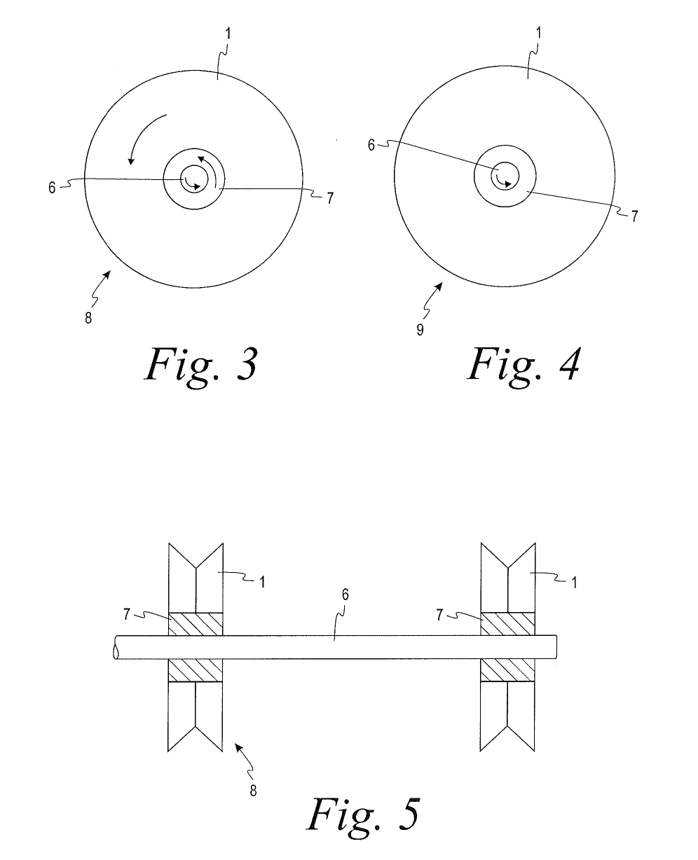

FIGS. 3, 4 and 5 explain the method for isolation of dual rotational inputs from each other when affixed onto a single accessory shaft 6. The pulley, clutch, shaft assemblies of FIGS. 1 and 2 are repeated in FIGS. 3, 4 and 5. The assembly of the pulley 1, clutch 7 and shaft 6 is shown generally at 8 in FIG. 3 and a second such assembly is shown generally at 9 in FIG. 4. These assemblies are identical and are assembled upon accessory shaft 6 of FIG. 5 so they are rotationally biased identically; that is in a manner that allows accessory shaft 6 to rotate and freewheel within either pulley when rotated in the same direction by the other, in this case, counterclockwise.

Pulley assembly 8 of FIG. 3 is assembled onto accessory shaft 6 in FIG. 5 with identical assembly 9 also assembled upon shaft 6 and adjacent to assembly 8 identically biased rotationally. When a counterclockwise rotational input force is applied to pulley 1 of assembly 8, as previously explained, pulley assembly 8 becomes locked to shaft 6 which now rotates in the same or counterclockwise direction. Shaft 6, rotating counterclockwise however, now freewheels in pulley assembly 9 imparting no rotational force to it.

When the contrary situation occurs and a counterclockwise rotational force is applied to pulley assembly 9, the clutch 7 affixed to it, locks pulley assembly 9 to shaft 6 rotating it counterclockwise causing shaft 6 to rotate counterclockwise and freewheel within pulley assembly 8 imparting no rotational force to pulley assembly 8.

Thus it can be seen, in a unidirectional drive system, rotational inputs onto the same drive shaft from two gear or pulley inputs mounted thereon, where each is powered from different power input sources, can be isolated one from the other in a manner that allows either input to operate the shaft without disturbing the other input drive line or source and to do so in a manner that allows one input source to seamlessly transition and take over the drive function while the other drive source's operation is terminated.

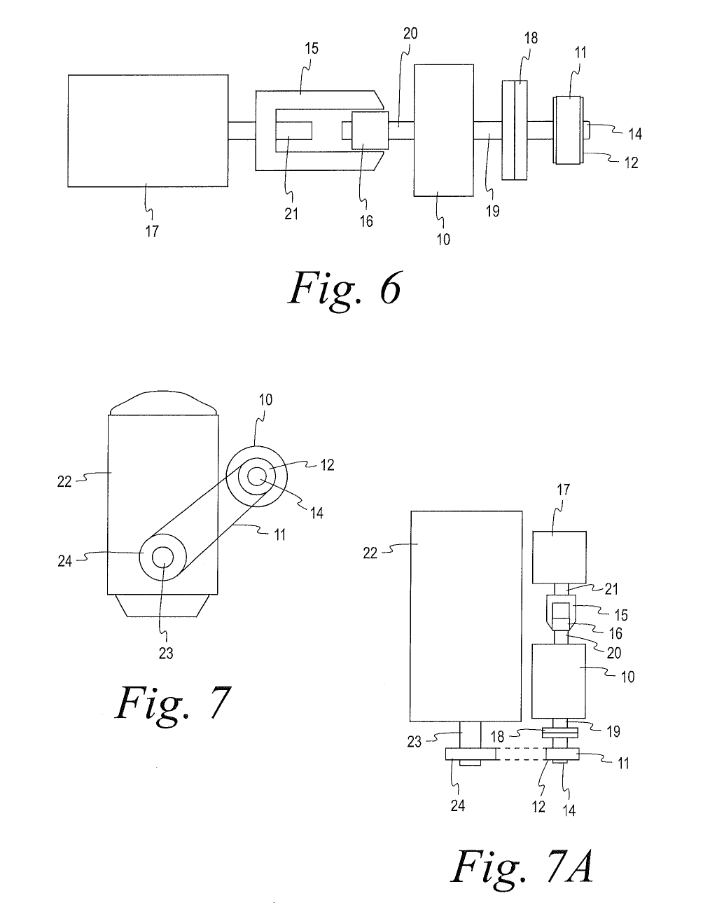

FIG. 6 illustrates an inline, shaft-to-shaft coupling 15 and 16 as it might be used to drive a modified air conditioner compressor 10 with an electric motor 17. FIGS. 7 and 7A show a traction engine 22 that has a shaft 23 which drives belt 11 via engine pulley 24 rotating pulley 12 affixed to shaft 14 of air conditioner 10 rotating it counterclockwise (as viewed from the pulley side) thus rotating air conditioner compressor 10 shaft 14 in a counterclockwise direction.

When the vehicle's heating, ventilating, air conditioning system (HVAC) calls for air conditioning, A/C compressor clutch 18 becomes engaged and imparts a counterclockwise rotation to compressor shaft 19 operating compressor 10 and imparting a counterclockwise rotation to compressor rear shaft extension 20 as well. However, counterclockwise rotating compressor shaft 20 freewheels within isolation clutch 16 imparting no rotational force to coupling 15, which is affixed to electric motor 17 shaft 21 thereby effectively isolating electric motor from any rotational force of its shaft 21 when compressor 10 is traction engine 22 driven.

When traction engine 22 becomes dormant, as when the vehicle is parked, compressor 10 can be driven by electric motor 17 as follows.

As will be shown later, if the vehicle is equipped either with an engine-off air conditioning control system or is equipped with a modified no-idle energy recovery interior heating system (FIG. 11), the HVAC control head can be powered up to provide electric motor operated and temperature modulated vehicle interior air conditioning as follows. Electric motor 17, when powered from the vehicle's normal bank of batteries, batteries reserved for A/C, or on hybrid vehicles, from the hybrid batteries, would operate compressor 10 by rotating shaft 21, coupling 15 and isolation clutch 16 counterclockwise. Counterclockwise rotation of isolation clutch 16 outer race 2 now causes clutch 16 to lock onto compressor 10 shaft 20 operating compressor.

With the engine running and when the HVAC system calls for A/C operation, A/C clutch 18 must become energized to connect compressor 10 shaft 19 to shaft 14 so as to be driven by traction engine 22 drive shaft 23 via belt 11 and pulley 12. In the inline drive of FIGS. 6 and 7, when the engine is turned off and no-idle A/C is needed, the no-idle energy recovery interior heating system of FIG. 11 must be actuated for A/C operation, causing A/C compressor 10 clutch 18 to engage as if the traction engine were running, thereby causing electric drive motor 17 shaft 21 to be connected via coupling 15, one-way clutch 16, shaft 20 and 19, clutch 18, shaft 14, pulley 12, belt 11 to dormant engine 22 pulley 24 and shaft 23 essentially locking electric motor 17 preventing A/C operation. To prevent A/C clutch 18 from engagement, it is disconnected by relay 63 in the modified no-idle energy recovery interior heating system of FIG. 11. An additional benefit of disconnecting A/C clutch 18 is reduced current draw from the dormant vehicle battery supply operating the engine-off air conditioning system.

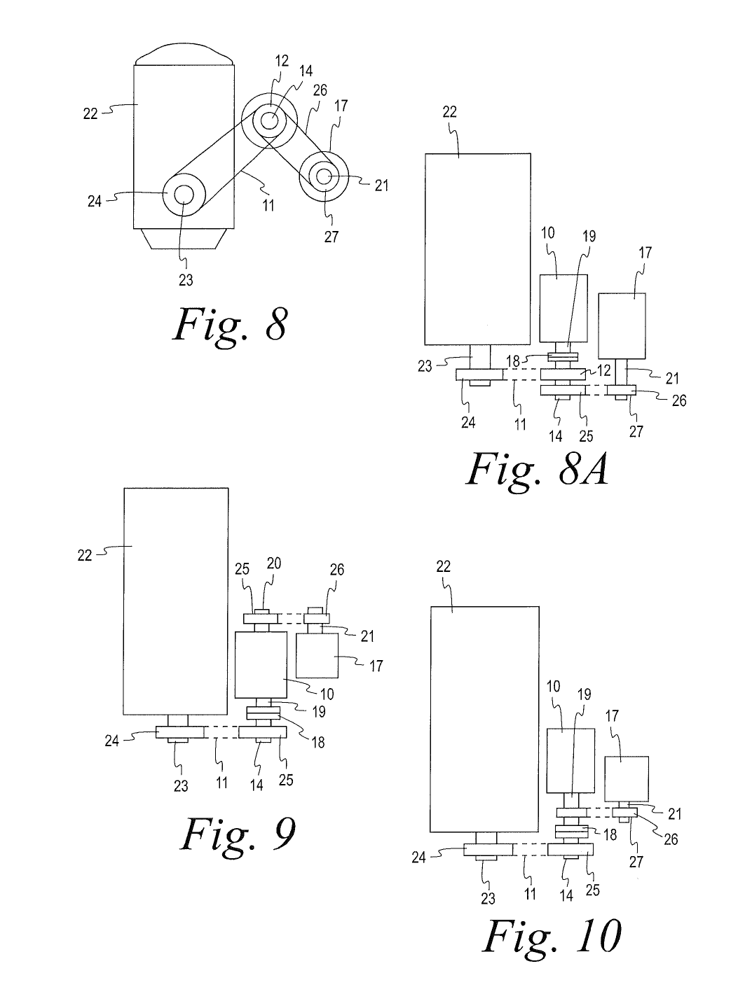

FIGS. 8 and 8A show the top and front view of a parallel belt drive to the A/C compressor 10 by an electric motor 17 or the traction engine 22. Compressor 10 pulleys 12 and 25 are each equipped with the one-way drive clutch previously described in FIGS. 1 through 5 with both oriented upon compressor shaft 14 to lock onto and drive shaft 14 when rotated in a counterclockwise direction as viewed from the front of engine 22 and freewheel when shaft 14 is rotated in a counterclockwise direction. When engine 22 shaft 23 rotates pulley 24 counterclockwise, belt 11 rotates pulley 12 counterclockwise causing clutch therein to lock onto compressor 10 shaft 14 rotating it counterclockwise as well. Counterclockwise rotating shaft 14 however, freewheels within pulley 25 leaving pulley 25, electric motor 17 and its drive line belt 26, pulley 27 shaft 21 undisturbed. When A/C clutch 18 is energized when air conditioning is called for, shaft 19 rotates operating compressor 10.

Conversely, when engine 22 becomes dormant and electric motor 17 is powered by the no-idle energy recovery interior heating system, motor 17 shaft 21, pulley 27 affixed thereto rotates belt 26 and pulley 25 in a counterclockwise direction. The one-way clutch affixed within pulley 25 also rotate counterclockwise and locks to shaft 14 imparting a counterclockwise rotation to it, causing shaft 14 to rotate counterclockwise and freewheel within dormant pulley 12 one-way clutch, leaving engine 22 A/C driveline pulley 12, belt 11, pulley 25 and engine shaft 23 dormant. When the A/C system becomes powered by the no-idle energy recovery system of FIG. 11 and calls for air conditioning, clutch 18 becomes energized transmitting counterclockwise rotational force to compressor 10 shaft 19, operating A/C compressor 10 and providing temperature modulated, vehicle interior, traction engine-off air conditioning. However as previously mentioned, actuation of A/C clutch 18 can draw down the dormant vehicle's limited battery supply more quickly and therefore is not the preferred location for connecting electric motor 17 to drive compressor 10.

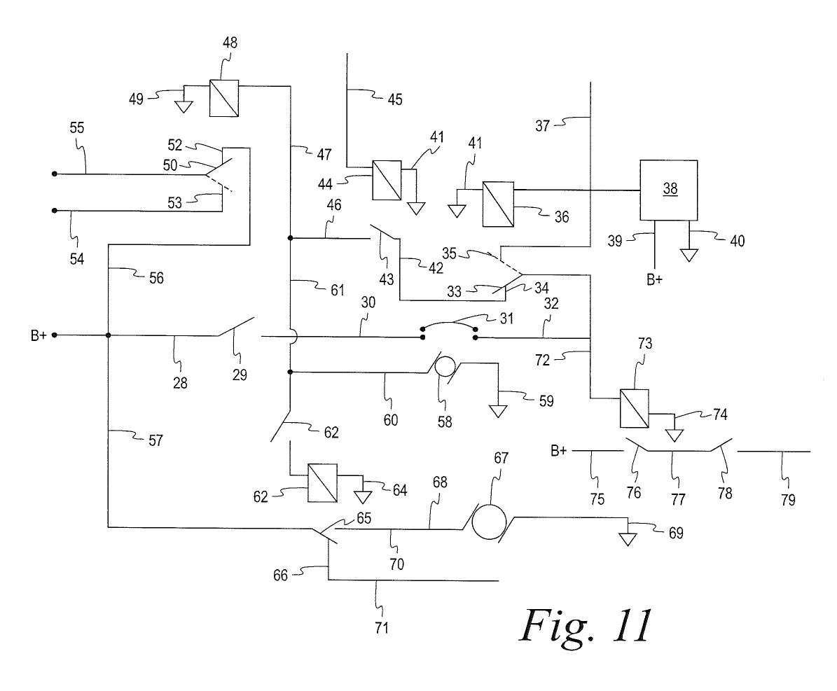

FIG. 10 shows the auxiliary (electric motor) 17 drive input relocated from compressor 10 clutch 18 input shaft 14 (as previously shown in FIG. 8) to A/C compressor 10 clutch 18 output shaft 19 therewith bypassing A/C 10 clutch 18 actuation whenever compressor is driven by auxiliary electric motor 17. Because A/C 10 clutch 18 is now only powered when traction engine 22 is running, only a single one-way isolation clutch is required instead of two, the same as the parallel, end-to-end drive of FIG. 6. Rotational bias as viewed from the front of engine 22 remains the same, counterclockwise as previously described in FIG. 8.

As can now be seen, when engine 22 driveline rotates the shaft 22 of compressor 10 counterclockwise and clutch 18 is engaged by need for air conditioning, compressor shaft 19 rotates counterclockwise operating compressor 10. Shaft 19 rotates counterclockwise and freewheels in one-way freewheeling clutch within pulley 25, thus imparting no rotational force to electric motor 17 driveline pulley 25, belt 26, pulley 27 and motor 17 shaft 21. Conversely, when traction engine 22 becomes dormant and electric motor 17 is powered, motor 17 driveline pulley 27 belt 26 rotate A/C compressor 10 pulley 25 counterclockwise locking onto compressor 10 shaft 19 thereby rotating and operating A/C compressor 10 with the engine off. Because the no-idle energy recovery system (FIG. 11) disconnects the electrical circuit to the A/C clutch 18 (as will be described later) whenever traction engine-off A/C is called for, the traction engine 22 driveline to A/C compressor 10 remains undisturbed effectively isolating one drive source from the other.

FIG. 9 shows a belt drive instead of the end-to-end coupling drive of FIG. 6. With rotational bias remaining counterclockwise when viewed from front of traction engine 22, auxiliary input electric motor 17 rotates shaft 21 with pulley 26 affixed thereto in a counterclockwise direction imparting through belt 26 a counterclockwise rotation to A/C compressor pulley 25. Pulley 25 is affixed to A/C compressor 10 rear input shaft 20 via the one-way clutch of this invention and rotationally mounted upon shaft 20 so as to lock thereto when rotated counterclockwise when viewed from front of traction engine 22, thereby rotating shaft 20 counterclockwise and operating A/C compressor 10 with traction engine 22 off. As described in the previous paragraph, when the traction engine 22 is off, the no-idle energy recovery system (FIG. 11) must be on to operate the engine-off A/C and while doing so in the operational modes described above, electrically disconnects A/C clutch 18, isolating the traction engine 22 drive line and the other accessories that may be connected thereto from disturbance by the electric motor 17 driven A/C compressor 10.

FIG. 11 is a general schematic of one of a number of patented electric or electronic circuits currently used to power and control no-idle energy recovery vehicle interior heating systems. These systems, as previously described, enable a vehicle's existing heating system to fully function with the ignition and traction engine off, enabling the existing vehicle heater to recover the waste heat energy that was generated and paid for while the vehicle was driven. As will be seen in the following description, the circuit as modified herein, is one of many control systems that can be utilized to power and modulate engine-off air conditioning with or without heating or A/C temperature modulation. The enabling drive isolation system therefore can be part of any type of heating and air conditioning operating system or can be fully functional and independent of any heating system.

FIG. 11 is a typical circuit schematic of many possible types of energy recovery or fuel-fired vehicle heating systems that can be modified to integrate the control and modulation of a no-idle heating and air conditioning system. FIG. 11 is a wiring schematic of an energy recovery system functioning as follows: Conductor 28 is connected to vehicle battery plus (+) and provides battery power via conductor 56 to relay 48 front contact 52. When the engine is running (ignition on), relay 48, grounded at 49, is dormant and transfer contact 50 is engaged with back contact 53 thereby connecting heater load on conductor 55 to vehicle battery plus via conductor 54 and powering heater normally with ignition on. When ignition is turned off, battery plus is disconnected from conductor 54 and heater operation ceases.

When engine-off heating or air conditioning is desired, system switch 29, connected to battery plus via conductor 28, is closed by the vehicle operator. Engine coolant sensor 31 closes when heated coolant is detected, conducting battery plus via conductors 30 and 32 to low voltage relay 36, transfer contact 33 which is normally engaged with back contact 34 as long as low battery voltage sensor 38, grounded at 40 and connected to vehicle battery at 39, senses the presence of sufficient battery power to operate systems with the engine off. Ignition on relay 44 grounded at 41, is connected via conductor 45 to any source that goes on and off with vehicle ignition; opening contact 43 when ignition is on (preventing system operation when engine is running) and becomes dormant when ignition is off thereby closing contact 43 and transferring battery via conductors 42, 46 and 47 powering relay 48 which causes transfer contact 50 to disengage contact 53 and engage contact 52 which now connects the vehicle heater on conductor 55 to connect to battery power via conductor 56 powering heater for full functioning with the ignition off.

With the heater fan and control system fully operational, the heater is enabled to recover the waste heat stored in the engine by utilizing a small electrically driven pump 58 to continue circulation of hot engine coolant to the heater which is normally supplied to the heater by the running traction engine's coolant circulating pump and works as follows. When heater relay 48 is powered by conductor 47 as previously described, battery plus is conducted via conductor 61 and 60 to pump 58 grounded at 50 and as can now be seen, turns off when the after run heating system ceases operation. When the traction engine is operating, the engine operated pump pumps hot engine coolant to the operating vehicle heater through the now dormant after run heating system pump 58.

When engine-off cooling is desired, A/C switch 62 is closed powering relay 63 grounded at 64, thereby moving transfer contact 65 to engagement with contact 70. This results in powering the air conditioning compressor drive motor 67 grounded at 69, thereby driving the air conditioning compressor from its second drive source without disturbing the dormant drive of the primary drive system.

Except when providing engine-off air conditioning, A/C relay 63 is dormant and transfer contact 65 is engaged with contact 66 and conductor 71. This enables actuation of the A/C clutch whenever the engine is on and air conditioning is called for by the HVAC controls of the vehicle's existing heating system. This clutch power must be interrupted in some models of vehicles when the heater is powered with the engine off. A/C relay 63 automatically interrupts this engine on circuit when the engine is off on vehicle models where this interruption is necessary.

Whenever low voltage monitor 38 encounters weak or low battery conditions, relay 36 normally dormant, operates closing down the no-idle heating/cooling system transferring battery power to conductor 37 which can then be utilized to perform a number of functions such as restarting the traction engine for charging the vehicle battery, starting an auxiliary engine to perform the same or other functions.

Another such example to perform a secondary but similar function is relay 73 grounded at 74 and is one of many different methods that could be used to perform a number of selected similar functions. In this example, relay 73 is powered whenever on/off switch 29 is closed and the system engine coolant temperature sensor 31 senses sufficiently high coolant temperatures to operate the no-idle energy recovery interior heating system. When thermostat 31 opens because engine coolant has cooled, the energy recovery system ceases to function deenergizing relay 73, causing transfer contact 76 to engage contact 75 and placing battery plus (+) onto conductor 77. If on/off switch 78 is closed, a number of secondary functions could be performed such as those that follow.

One of these is particularly applicable to sleeper type vehicles where long term (frequently eight to ten or twelve hours) of engine-off heating or air conditioning may be required. Engine-off, energy recovery interior heating systems are capable of providing only 3½ to 4 hours or less of interior heating in a freezing ambient, being very dependent on outside temperatures and wind. The present invention, modified as described above, could then provide the need for extended heating by a number of methods that will be covered in greater detail later.

One of these methods would be to restart the traction or an auxiliary engine so as to recharge the battery and to reheat the engine coolant. Another method would be to start a fuel-fired heater to continue interior heating by heating either the interior cabin air or preferably by reheating the engine coolant, terminating operation when coolant temperatures reach maximum temperatures and then allowing the energy recovery system to function again for hours with the engine off. As previously described, air conditioning could also be continuously provided in such over the road and other vehicles as the engine cycles on and off based on criteria such as battery charge and voltage. A more specific application of this technology is covered after the description of this invention as applicable to hybrid vehicles which follows.

As can now be seen, a vehicle equipped with the dual drive isolation system of this invention independently or in combination with an energy recovery no-idle interior heating system unmodified or modified as proposed herein, can be enabled to utilize the vehicle's existing heating and cooling components to provide both engine on and engine-off (no-idle) interior heating, full air conditioning or temperature modulated air conditioning with little penalty in added weight, volume, initial cost or added maintenance. Existing accessories are enabled to operate with the traction engine on or off.

As previously stated, even with an idling engine, heating and cooling times are limited by many factors such as outdoor temperatures, size of vehicle's engine cooling system, battery size and capacity and size of vehicle interior space. However, when applied to hybrid work vehicles, the systems proposed in this invention can provide comparatively simple continuous worksite heating or air conditioning as follows.

As previously described, there are two types of hybrid vehicles, electric and hydraulic and two types of electric hybrid vehicles. The first electric hybrid alternates vehicle traction or drive between an internal combustion engine and an electrically powered traction motor, alternating between them or operating both when required. These types of hybrid vehicles are usually reserved for passenger transport and will be dealt with later. The truck hybrid is divided between hydraulic and electric. In the case of the hydraulic hybrid the hydraulic is used to recover kinetic energy and to provide alternate traction drive assist while the electric hybrid mainly provides electrical energy for work related functions normally supplied in older vehicles by PTO (power take off) shafts operating hydraulic pumps to operate hydraulically operated tools like boom arms on power company trucks for example or lift gates and the like.

Currently, traction engines run continuously while at work sites generating hydraulic power to operate equipment powered from the engine PTO shaft. The interior of such vehicles can then provide the work crew a continuously warmed or air conditioned refuge during lunch, rest or mandatory paperwork periods.

This type of hybrid work vehicle cycles the traction engine on and off based on the need to recharge the work battery (or hydraulic accumulator). During the times when the engine is off, the interior becomes unheated or un-cooled for significant periods of time. With the energy recovery system installed and engaged, interior heating and cooling is provided continuously and seamlessly as follows: with the engine running the existing heater provides either interior heating or temperature modulated air conditioning. When the engine turns off because the hybrid battery is fully charged, the no-idle energy recovery system continues heating or air conditioning as previously described herein.

As can now be seen, the system of this invention installed on hybrid vehicles, significantly reduces fuel consumption and air pollution, conserves a diminishing natural resource, significantly increases vehicle life, lowers operating and repair cost and provides continuous comfort in every season.

The passenger hybrid, where internal combustion engines and electric motors provide, in combination or separately, vehicle propulsion, the addition of the energy recovery system would provide both internal combustion engine-off heating and cooling at stop lights and during short periods while the vehicle is stationary or parked. Currently, when heat is called for, the internal combustion engine does not shut off because of the need to continue circulation of engine coolant to the heater. With the energy recovery system installed on such vehicles, internal combustion engine shut down at red lights in winter could easily be accomplished conserving fuel as in warm weather.

As previously stated the air conditioning system compressor, driven from dual sources and isolated from each other by the drive isolation system of this invention, provides two benefits for engine-off air conditioning. The first is that it does not have to quickly cool down a hot vehicle interior. It only needs to maintain it since the interior was cooled down originally by the primary drive source the traction engine which is capable of providing the initial high power input to accomplish this. Upon engine shutdown, this electrically driven, battery powered system only needs to maintain cool interiors, consuming significantly less power and requiring a much smaller horsepower input from a highly limited source. Secondly if a temperature modulating source such as the energy recovery heating system mentioned above is not available, temperature modulation can be obtained by controlling the electric drive motor's speed by one of many available electronic speed controls such as PWM (pulse width modulation) speed control which in turn is controlled by a cabin temperature sensor. The additional benefit is even less power consumption from a limited source, the vehicle's battery or the hybrid battery.

The following describes how the application of the drive isolation system of this invention to drive traction engine accessories from dual drive sources can be combined with an energy recovery heating system and an auxiliary internal combustion engine that is closely integrated with the traction engine, and how this combination can provide long term APU functions such as power, heating and cooling at considerably less weight, space and initial cost than current systems.

The close integration of the auxiliary and traction engine, particularly the engine cooling system as proposed herein, has benefits that are in most instances necessary to what is proposed in this final section particularly long term interior heating by the energy recovery system. Therefore this invention proposes that the auxiliary engine be integrated with or mounted near or upon the traction engine, sharing where possible traction engine operating systems such as engine coolant (which is mandatory for long term energy recovery system heating), traction engine lubricating oil and oil filter, fuel and fuel filtration, combustion air and air filtration and exhaust noise, cleaning and processing when and where practical.

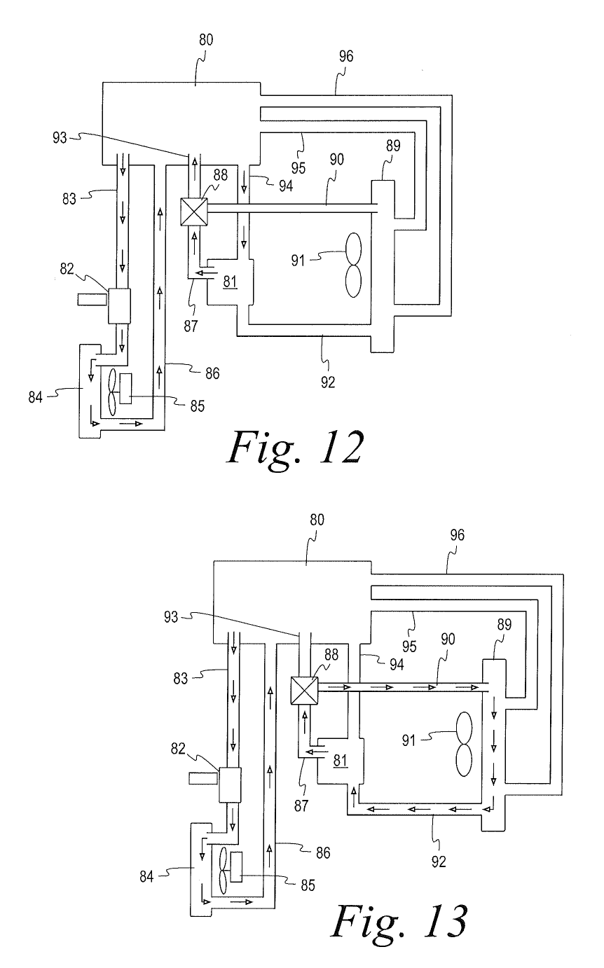

FIGS. 12 and 13 illustrate the application of this invention to a sleeper type vehicle where long term, mandatory occupancy requires long term heating, cooling and electric power generation capabilities. FIG. 12 illustrates the flow of engine coolant when the traction engine 80 is dormant and auxiliary engine 81 is running to operate the traction engine accessories, using the drive isolation system of this invention, to provide engine-off domestic amenities to the sleeper portion of the stationary vehicle. It will be understood that the traction engine 80 is in fluid communication with the shared radiator through conduits 95 and 96. Thus, when the traction engine 80 is running coolant for the traction engine may be circulated through conduits 95 and 96 to the shared radiator 89. The usual thermostat in the traction engine 80 or conduits 95, 96 may be used to govern whether the coolant circulates to the radiator 89 or not. However, as mentioned above, FIGS. 12 and 13 illustrate coolant flow with the traction engine off.

Looking at FIG. 12, energy recovery heating system pump 82 circulates hot engine coolant from the top of traction engine 80 via conduit 83 to vehicle interior heater 84, while powering heater controls and fan 85 with the traction engine off. Pump 82 returns engine coolant from heater 84 to traction engine 80 via return conduit 86. Upon shutdown, and traction engine coolant being warm from the vehicle having been driven over the road and with traction engine 80 now off, energy recovery heating system now powers heater 84 operating ERS pump 82 and provides long term engine-off interior heating. If domestic amenities are called for (such as 110VAC power or vehicle battery charging) or if, after two to four hours of no-idle heating (depending on size of vehicle and ambient temperature), reheating of engine coolant for maintaining interior heating is called for, auxiliary engine 81 is restarted. Sharing the coolant of traction engine 80, auxiliary engine 81 will run and reheat the coolant, pumping hot coolant via conduits 94 and 87, diverter valve 88, and conduit 93 to dormant traction engine 80 for continuing interior heating while operating shared traction engine accessories such as an alternator and recharging the batteries. In this case the conduits 90 and 92 are not used. As previously mentioned, a fuel-fired or electric heater can be started instead of the auxiliary engine 81 if reheating of the engine coolant is the only need being called for and operation of other accessories such as battery charging is not called for. In either case, the vehicle's existing energy recovery system pump 82 continues circulation of the vehicle's heater 84, 85 transferring the heat energy from the engine coolant to the entering air, thereby seamlessly continuing interior heating.

FIG. 13 shows the same system operating during hot or moderate weather. Under these conditions little or no heat may be called for and the energy recovery system operation can be manually terminated by turning off system switch 29 of FIG. 11. If ventilation is required, switch 29 can be left on and the heating system adjusted for ventilation only by the heater fan 85. Except for the call for such other functions such as battery charging, (particularly when air conditioning is required) auxiliary engine 81 may not be required to run. When battery charging or air conditioning is called for, auxiliary engine 81 may be called to run for extended time periods.

Under warm weather conditions, when the traction engine coolant may be at maximum temperatures, auxiliary engine 81 can no longer be cooled sufficiently for long term safe operation by returning its coolant to traction engine 80 as shown in FIG. 12. FIG. 13 illustrates the change in coolant flow that would automatically take place as follows. An engine coolant temperature sensor (not shown) operates diverter valve 88 redirecting coolant flow from auxiliary engine 81 to shared radiator 89 via conduit 90 while operating radiator fan 91 and returning cooled coolant to auxiliary engine 81 via conduit 92. Thus while auxiliary engine 81 is running to operate the air conditioner, auxiliary engine 81 coolant is cooled in the shared radiator 89 and by the operation of radiator fan 91. In turn, fan 91 operates cooling A/C condenser (not shown).

It should be noted that whenever engine-off air conditioning is called for in this document, radiator fan 91 must operate for cooling the condenser. In the various systems and vehicles described above this can be provided by running existing electrically driven fans, the vehicle's existing belt driven radiator fan (when auxiliary engine is running) or by providing a separate auxiliary, electrically driven fan specific for engine-off air conditioning. For simplifying the description of the drive isolation system of this invention, reference to this requirement was omitted until referenced here.

As can now be seen by reviewing FIGS. 6 to 10, the air conditioning compressor and radiator fan can each be driven by any combination of drives chosen by the vehicle manufacturer. When the traction engine is running the air conditioner compressor or other accessories can be electric motor or belt driven by the traction engine while the radiator fan 91 can also be belt or electric motor driven. When the traction engine is dormant, all of the same accessories can be either belt or electric motor driven another power input source in the same combination as when traction engine was running or in virtually any new drive combination chosen by the vehicle manufacturer.

This versatile drive isolation system thus enables a vehicle manufacturer to provide virtually any traction engine driven accessory function with the engine on or off on all types of vehicles and at the lowest penalties of initial cost, operational cost, weight, space, energy efficiency, environmental impact and maintenance cost.

What is claimed is:

1. A motor vehicle, comprising:
a traction engine;
a shared radiator containing coolant and in fluid communication with the traction engine;
an auxiliary engine in fluid communication with the traction engine and the shared radiator; and
a diverter valve for selectively directing coolant to circulate between the auxiliary engine and one of the shared radiator and traction engine when the auxiliary engine is running.

2. The motor vehicle of claim 1, comprising:
a heater in fluid communication with the traction engine;
a fan arranged to cause air flow over the heater and into the vehicle; and
an energy recovery heating pump in fluid communication with the traction engine and the heater for circulating coolant between the traction engine and the heater when the traction engine is off.

3. The motor vehicle of claim 1, comprising:
an air conditioning compressor having a drive shaft;
a compressor clutch having a first portion attached to the drive shaft and a second portion selectably engageable with the first portion;
a drive isolation system mounted on the drive shaft and including an isolation clutch and a pulley, the isolation clutch connecting the drive shaft to the pulley for rotation therewith when the pulley is driven, the isolation clutch disconnecting the drive shaft from the pulley when the drive shaft is driven; and
an electric motor, one of the traction engine and the electric motor being connected to the compressor clutch's second portion and the other of the traction engine and the electric motor being connected to the drive isolation system's pulley such that the drive shaft can be driven by multiple power input sources.

4. The motor vehicle of claim 1 further comprising;
a heater in fluid communication with the traction engine;
a fan arranged to cause air flow over the heater and into the vehicle;
an energy recovery heating pump in fluid communication with the traction engine and the heater for circulating coolant between the traction engine and the heater when the traction engine is off;
an air conditioning compressor having a drive shaft;
a compressor clutch having a first portion attached to the drive shaft and a second portion selectably engageable with the first portion;
a drive isolation system mounted on the drive shaft and including an isolation clutch and a pulley, the isolation clutch connecting the drive shaft to the pulley for rotation therewith when the pulley is driven, the isolation clutch disconnecting the drive shaft from the pulley when the drive shaft is driven; and
an electric motor, one of the traction engine and the electric motor being connected to the compressor clutch's second portion and the other of the traction engine and the electric motor being connected to the drive isolation system's pulley such that the drive shaft can be driven by multiple power input sources.

5. The motor vehicle of claim 1 further comprising a filter, the traction engine and auxiliary engine being in fluid communication with the filter such that both engines use a common filter.

6. The motor vehicle of claim 5 wherein the filter is an oil filter.

7. The motor vehicle of claim 5 wherein the filter is a fuel filter.

8. The motor vehicle of claim 5 wherein the filter is an air filter.

9. The motor vehicle of claim 1 further comprising an exhaust system connected to both the traction engine and the auxiliary engine.

10. A motor vehicle comprising a traction engine and an auxiliary engine mounted on or near the traction engine where the auxiliary engine can share the traction engine operating apparatus including engine cooling.

11. The motor vehicle of claim 10 wherein the shared traction engine operating apparatus further includes oil filtration.

12. The motor vehicle of claim 10 wherein the shared traction engine operating apparatus further includes fuel filtration.

13. The motor vehicle of claim 10 wherein the shared traction engine operating apparatus further includes air filtration.

14. The motor vehicle of claim 10, comprising:
a heater in fluid communication with the traction engine;
a fan arranged to cause air flow over the heater and into the vehicle; and
an energy recovery heating pump in fluid communication with the traction engine and the heater for circulating coolant between the traction engine and the heater when the traction engine is off.

15. The motor vehicle of claim 10, comprising:
an air conditioning compressor having a drive shaft;
a compressor clutch having a first portion attached to the drive shaft and a second portion selectably engageable with the first portion;
a drive isolation system mounted on the drive shaft and including an isolation clutch and a pulley, the isolation clutch connecting the drive shaft to the pulley for rotation therewith when the pulley is driven, the isolation clutch disconnecting the drive shaft from the pulley when the drive shaft is driven; and
an electric motor, one of the traction engine and the electric motor being connected to the compressor clutch's second portion and the other of the traction engine and the electric motor being connected to the drive isolation system's pulley such that the drive shaft can be driven by multiple power input sources.

16. The motor vehicle of claim 10 further comprising;
a heater in fluid communication with the traction engine;
a fan arranged to cause air flow over the heater and into the vehicle;
an energy recovery heating pump in fluid communication with the traction engine and the heater for circulating coolant between the traction engine and the heater when the traction engine is off;
an air conditioning compressor having a drive shaft;
a compressor clutch having a first portion attached to the drive shaft and a second portion selectably engageable with the first portion;
a drive isolation system mounted on the drive shaft and including an isolation clutch and a pulley, the isolation clutch connecting the drive shaft to the pulley for rotation therewith when the pulley is driven, the isolation clutch disconnecting the drive shaft from the pulley when the drive shaft is driven; and
an electric motor, one of the traction engine and the electric motor being connected to the compressor clutch's second portion and the other of the traction engine and the electric motor being connected to the drive isolation system's pulley such that the drive shaft can be driven by multiple power input sources.
